(19) United States
(12) Patent Application Publication
(10) Pub. No.: US 2026/0127628 A1
(43) Pub. Date: May 7, 2026

(54) Method for Data Collection Using Consumer Choice

(71) Applicant: George C. Beighley, Jr., Columbia, SC (US)

(72) Inventor: George C. Beighley, Jr., Columbia, SC (US)

(21) Appl. No.: 19/376,924

(22) Filed: Nov. 1, 2025

Related U.S. Application Data
(60) Provisional application No. 63/715,066, filed on Nov. 1, 2024.

(51) Int. Cl. G06Q 30/0207

(52) U.S. Cl. CPC G06Q 30/0212

(57) ABSTRACT

An economic method applied through a computer, comprising: outputting the opportunity for a first user to enter a sweepstakes for a first item or second item at a first odds; receiving input of a choice by a first user for the sweepstakes a first or second item; outputting a first sweepstakes ticket for the first user; changing the first odds; outputting the opportunity for a first user to enter a sweepstakes for a first item or second item at a second odds; receiving input of a choice by a first user for the sweepstakes a first or second item; outputting a second sweepstakes ticket for the first user; outputting a visual image of the drawing to determine the winner of the sweepstakes; and, holding a drawing for at least one sweepstakes ticket to determine the winner of the sweepstakes

### RELATED APPLICATIONS

This application claims the benefit of priority under 35 USC § 119(e) of U.S. Provisional Ser. No. 63/715,066 filed Nov. 1, 2024 the contents of which is incorporated herein by reference in its entireties.

### FIELD OF THE INVENTION

The present invention, in some embodiments thereof, relates to data collection and, more particularly, but not exclusively, to methods using consumer choice.

### SUMMARY OF THE INVENTION

According to an aspect of some embodiments of the present invention there is provided an economic method applied through a computer, comprising: outputting the opportunity for a first user to enter a sweepstakes for a first item or second item at a first odds; receiving input of a choice by a first user for the sweepstakes a first or second item; outputting a first sweepstakes ticket for the first user; changing the first odds; outputting the opportunity for a first user to enter a sweepstakes for a first item or second item at a second odds; receiving input of a choice by a first user for the sweepstakes a first or second item; outputting a second sweepstakes ticket for the first user; outputting a visual image of the drawing to determine the winner of the sweepstakes; and, holding a drawing for at least one sweepstakes ticket to determine the winner of the sweepstakes.

In an embodiment of the invention, the first and second items are of the same class.

In an embodiment of the invention, the first and second items are of different classes.

In an embodiment of the invention, the preference for the sweepstakes for a first item or second item and the odds are combined to yield an estimated price for the item.

In an embodiment of the invention, the preference for the sweepstakes for a first item or second item and the odds are combined to yield an estimated demand for the item.

In an embodiment of the invention, certain steps are repeated multiple times with multiple different goods in the same class to determine a price index.

In an additional embodiment of the invention, the sweepstakes process is used to determine the relative demand of one product relative to the demand of competing products.

In an additional embodiment of the invention, the sweepstakes process is used to determine the relative demand of one product relative to cash.

In an additional embodiment of the invention, multiple products are compared to cash in order to determine the relative consumer demand for cash.

In an additional embodiment of the invention, participants in the sweepstakes may contribute something of value to increase the chances of a winning the sweepstakes.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example, are not necessarily to scale and are for purposes of illustrative discussion of embodiments of the invention. In this regard, the description taken with the drawings makes apparent to those skilled in the art how embodiments of the invention may be practiced.

In the drawings:

FIGS. 1-7, illustrate an exemplary design of the application, in accordance with an exemplary embodiment of the invention;

FIGS. 8 and 9 illustrate earnings trading methodology, in accordance with an exemplary embodiment of the invention;

FIGS. 10, 11 and 12 illustrate shareholder activism trading methodology, in accordance with an exemplary embodiment of the invention;

FIGS. 13 and 14 illustrate consumer demand trading methodology, in accordance with an exemplary embodiment of the invention;

FIGS. 15, 16, and 17 illustrate inflation trading on a company methodology, in accordance with an exemplary embodiment of the invention; and

FIGS. 18 and 19 inflation trading on a market methodology, in accordance with an exemplary embodiment of the invention.

### DESCRIPTION OF SPECIFIC EMBODIMENTS OF THE INVENTION

The present invention, in some embodiments thereof, relates to data collection and, more particularly, but not exclusively, to methods using consumer choice.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The breakthrough is in realizing it is possible to run this economic experiment without charging people, while generating a profit, and gathering data. The profit comes from several sources: providing consumer demand and inflation data to Wall Street, advertising data (give away one handbag, sell 100), and providing pricing services for sellers of fashion items (how much should I charge for my new bag?).

A secondary goal of Operation Stella is to help reduce inflation on fashion items which account for 2% the gross domestic product of the world by providing policy makers with an understanding of an economic concept I refer to as “relative price relations theory” in the consumer goods sector. Operation Stella is an experiment that examines the price relationship between elite, intermediate, and low designer handbags to determine if the “price preference relationship” between items holds when the prices of the items change. If the price preference relationship holds through lowering the price of the elite item, then through decreasing prices on the elite items, through my fashion AI system, we can cause a collective lowering of prices.

The objective of the secondary goal is to find something known as the “Stella Function” which is an economic equation economists will use to calculate the effect price changes of elite goods have on intermediate and low cost goods. If successful, the Stella Function will be used by professional economists all over the world to combat inflation by providing incentives to reduce the price of elite goods to reach a target inflation goal by this trickledown effect.

### Design of Application:

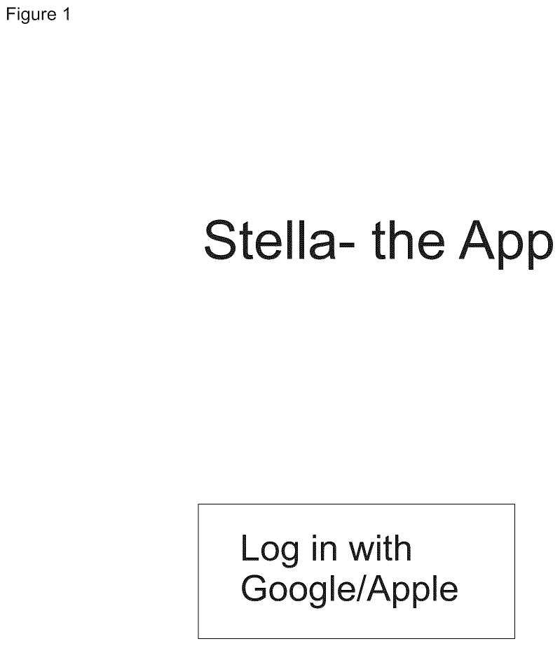

FIGS. 1 through 7, illustrate an exemplary design of the application. As shown in FIG. 1, a feature to allow users to log in with google or apple. Plus, there needs to be a feature that allows users to create an account with the computer system.

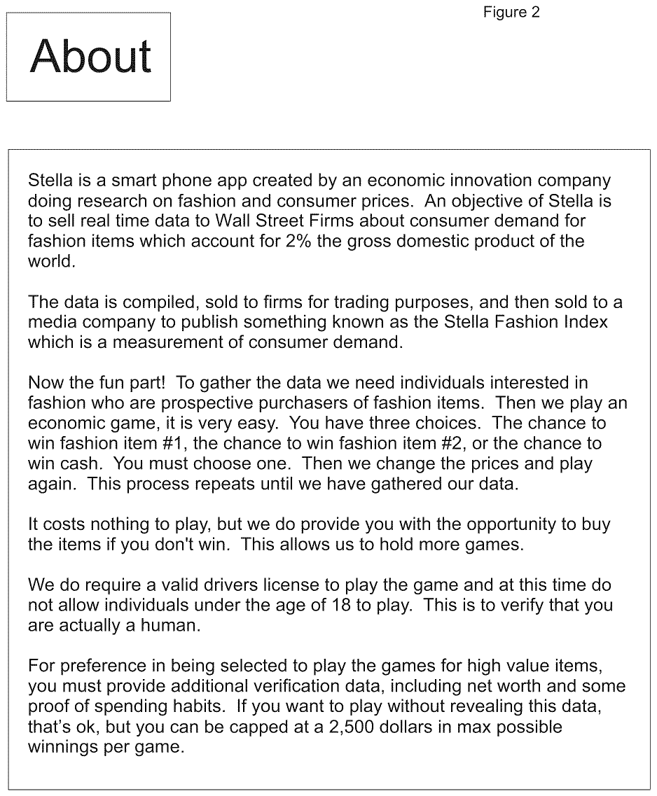

As shown in FIG. 2. An “about us” page which introduces the rules of the experiment.

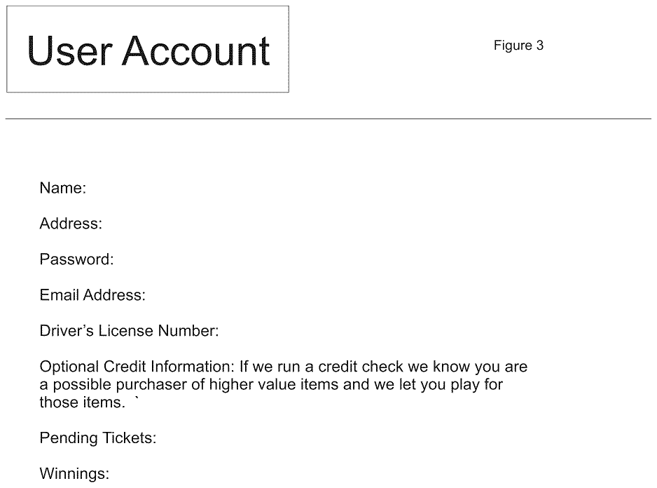

As shown in FIG. 3, Demographic information and winnings associated with the user accounts.

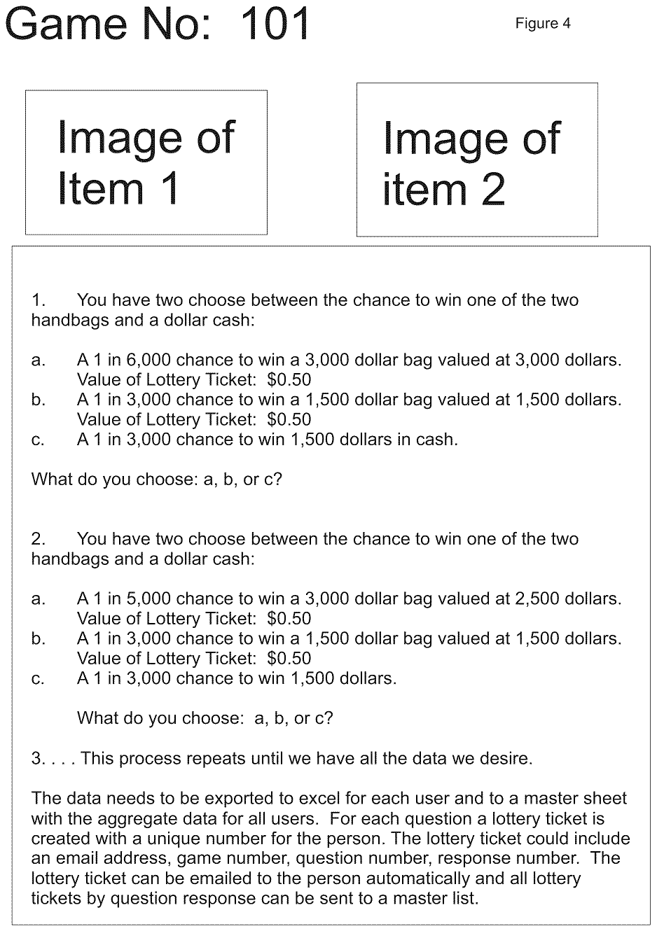

As shown in FIG. 4, a form where users engage in the experiment which includes basic pictures of the items, the question. The answers need to be downloaded to excel spreadsheets, where templates for what we are measuring are included. These templates are included in attached documents.

The data needs to be exported to excel for each user and to a master sheet with the aggregate data for all users. For each question there needs to be a sweepstakes ticket created with a unique number for the person. The sweepstakes ticket needs to be an email address, game number, question number, response number. The sweepstakes ticket needs to be emailed to the person automatically and all sweepstakes tickets by question response need to be sent to a master list.

There also needs to be a user ranking based on factors economists use to determine the seriousness of the user in approaching the experiment. Users who answer within economic norms are given a higher score.

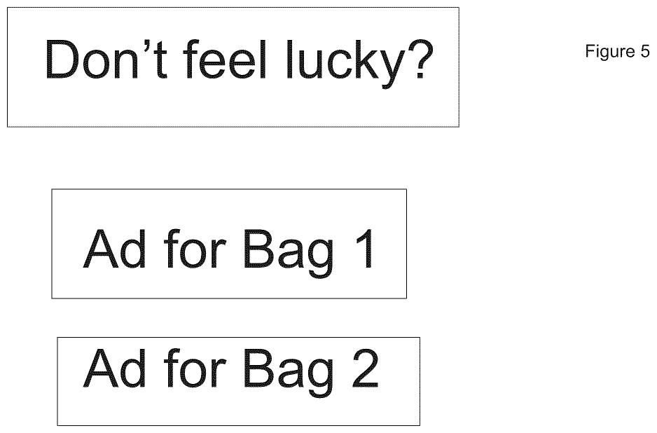

As shown in FIG. 5, a link to ads of the same product where there is a pay per sale compensation.

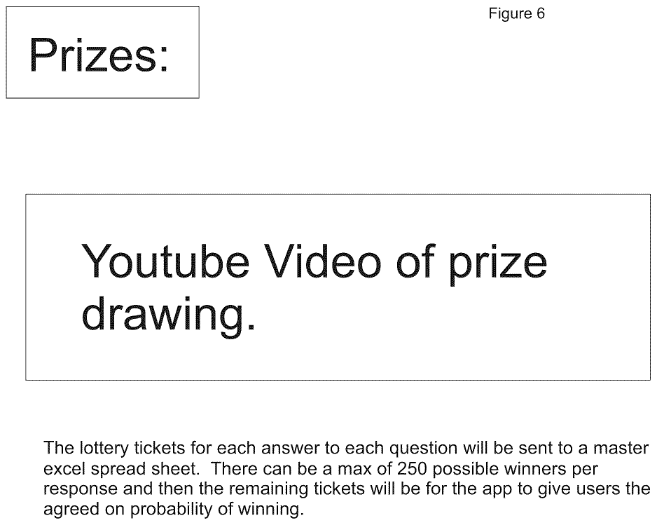

As shown in FIG. 6, a section for the prizes, where the drawing takes place and the winner of the prize is announced. The sweepstakes tickets for each answer to each question will be sent to a master excel spread sheet. As many users as wish to play will be permitted to play as long as the odds remain as advertised. When there are limited number of participants additional remaining tickets will be added that belong to the holder of the sweepstakes to give users the agreed on probability of winning. There will be a drawing where numbers are pulled out of a ball similar to power ball.

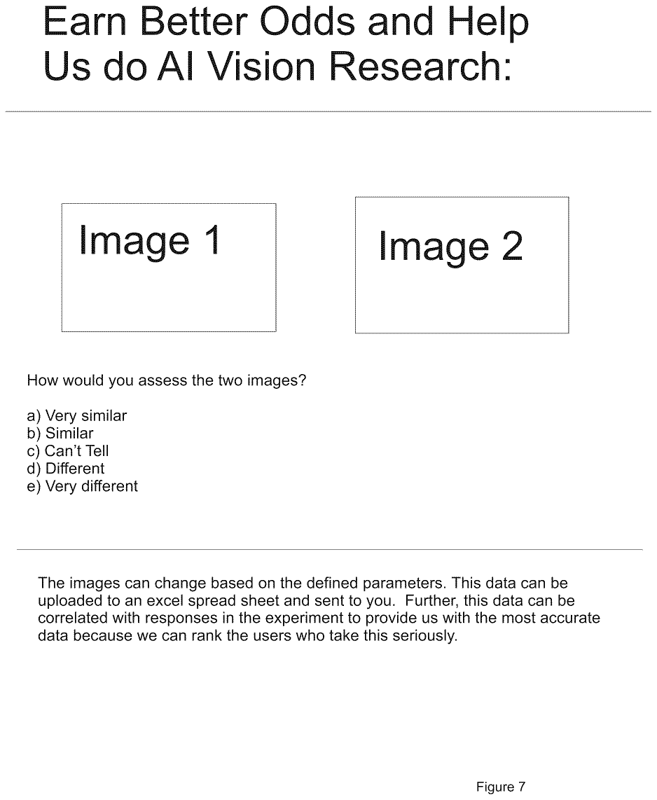

As shown in FIG. 7, a place to ask questions related to the degree of similarity between two items or two sounds. Individuals can earn better odds for participating in these experiments.

### Economic Basis:

One of the leading experts in behavioral economics is a professor from the University of Virginia by the name of Charles Holt¹. Many years ago, Professor Holt ¹ https://economic.virgina.edu/people/profile/cah2k designed an experiment meant to measure the behavior of individuals in making economic decisions².² Holt, Charles A. and Susan K. Laury, 2002 “Risk Aversion and Incentive Effects,” American Economic Review, 92(5): 1644-1655

The revenue to sustain the business comes from five data sources: the data gathered from the choice the player makes, advertising revenue, and providing pricing services for makers of unique goods, providing real time inflation data, and collecting revenue for users seeking better odds to win the sweepstakes.

### Revenue Sources:

### Data for Wall Street:

Currently there are numerous Wall Street firms who trade on inflation and earnings data. The objective is to target these firms as clients. We run an experiment where individuals must choose between a chance to win one of two items or cash. If the player chooses one item over another, it means there is more of a demand for that item over the second item. If the Player chooses cash over both items, it means that neither item is desirable. Further, we can change the odds to model the change of this demand by price and set our own profit margins. This data can then be sold to Wall Street to better assess earnings and inflation data before it happens. Through selling the data we can allow for the fun of the sweepstakes without charging any individual to participate.

### EXAMPLES

### Earnings Trading:

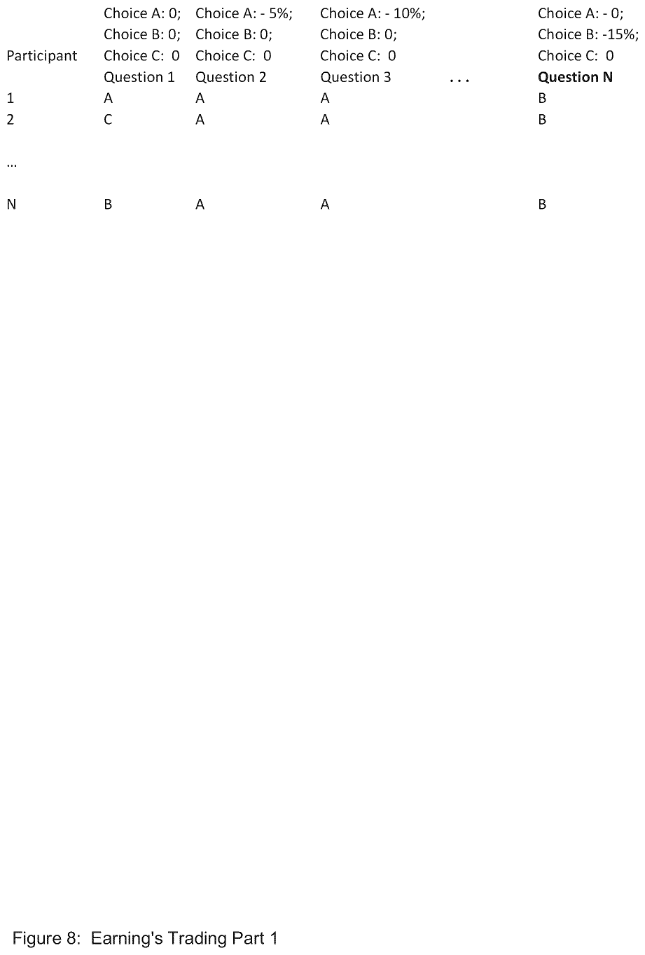

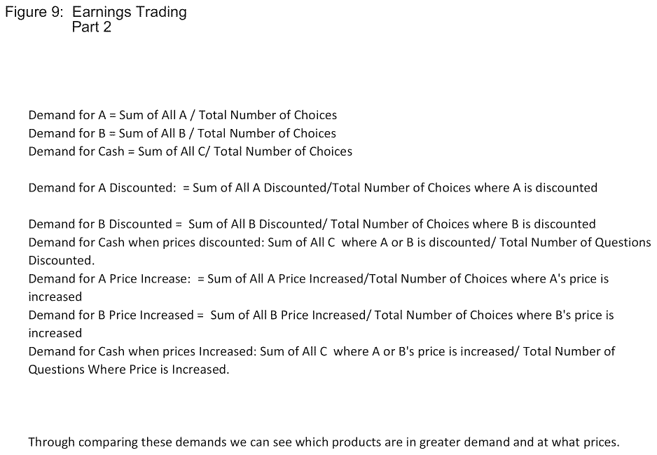

As shown in FIGS. 8 and 9, a hedge fund wants to know if they should invest in a fashion company A and if so what price it should pay for the stock. They contact us, and we run experiments comparing the demand for the products of fashion company A to competing products. We can give them real time demand data for this company which, based on publicly available online sources combined with our demand data, allow them to estimate whether sales will be strong or weak. This means they can know the performance of the company before the annual or quarterly report is published.

### Shareholder Activism Trading:

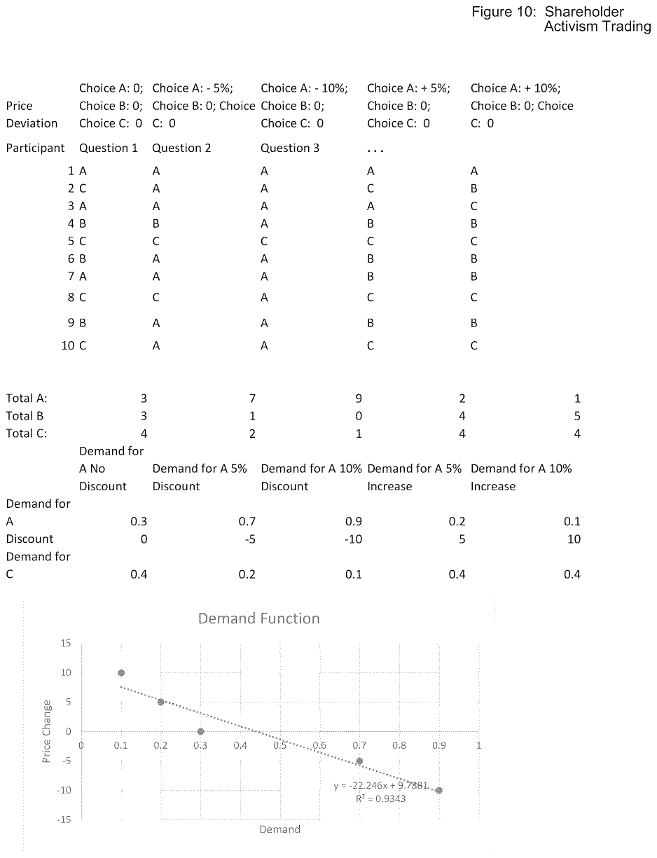

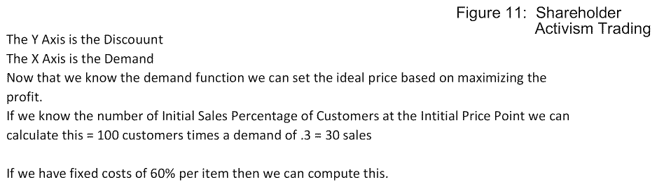

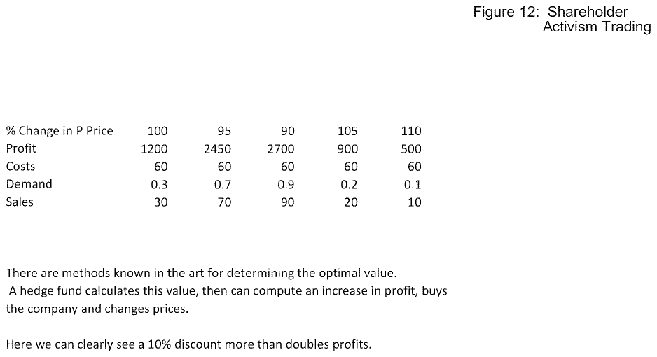

As shown in FIGS. 10, 11 and 12, a hedge fund wants to know if it can purchase the shares of fashion company A and then encourage fashion company A to raise or lower prices, yielding millions in profit if successful. They contact us, we run experiments changing the price of all the items the company sells relative to their competitors'price. In doing so we can determine the demand function for each item the company sells and its proper price point. We provide this data to the hedge fund that buys shares of stock in fashion company A, changes prices, and greatly increases profit.

### Consumer Demand Trading:

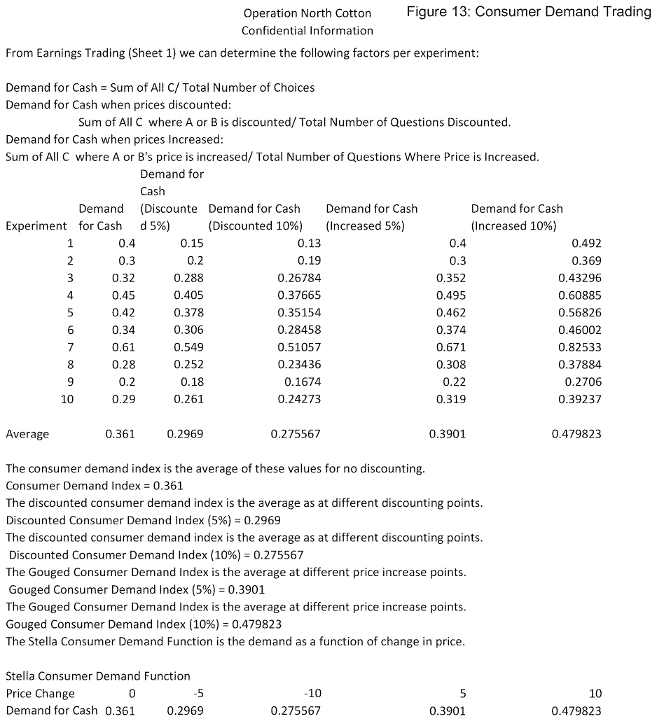

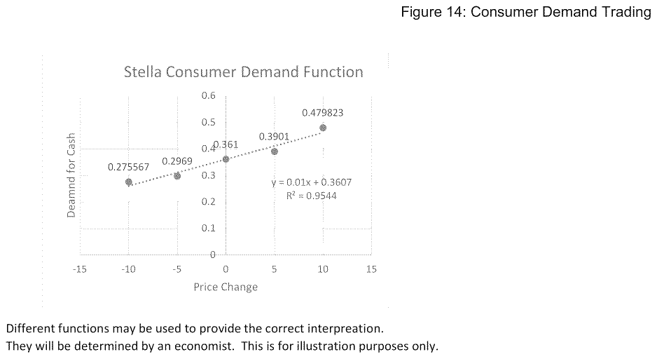

As shown in FIGS. 13 and 14, it is possible for us to create something known as the Stella Consumer Demand Index. It is a real time measurement of the demand for all products versus cash. We run experiments for all types of fashion items and compare the choice of any item over cash. The more times cash wins it shows demand is weak. The more times an item wins it shows that demand is stronger. We take the sum of all times cash wins divided by the total number of times an item wins for all experiments. This measurement is something known as the Stella Consumer Demand Index, which measures the demand for all products. It is possible to sell this data to Bloomberg and other financial publishers.

### Inflation Trading: Part 1: Existing Inflation for the Market

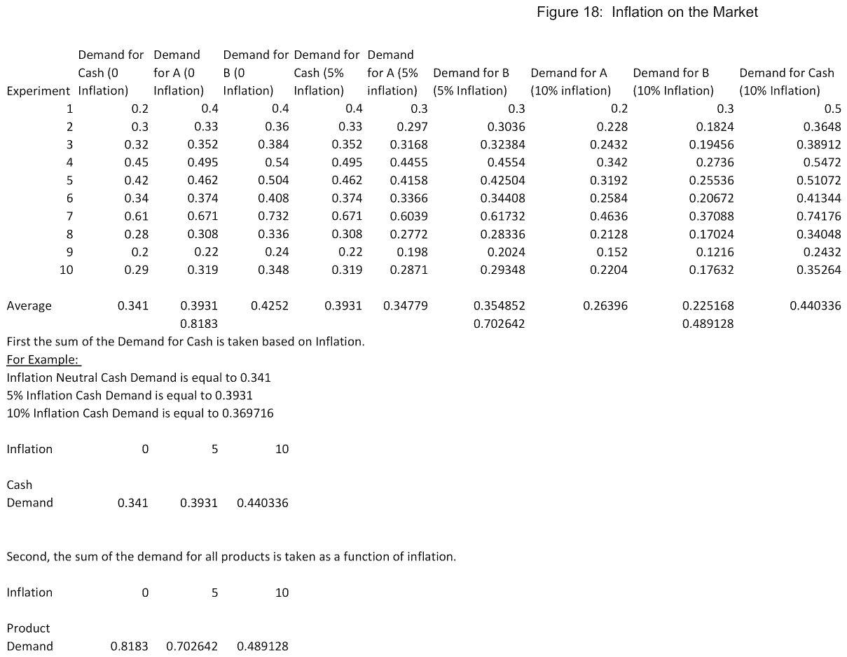

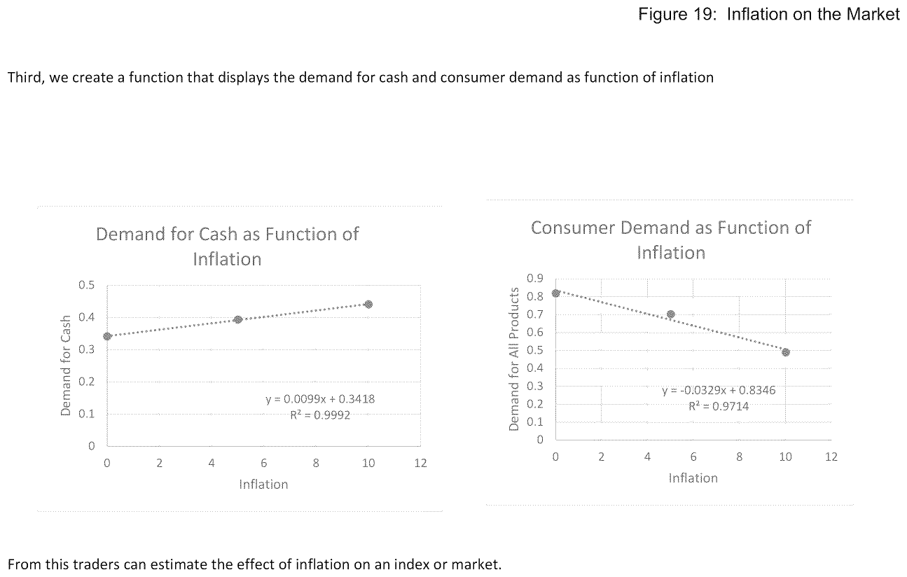

As shown in FIGS. 18 and 19, Wall Street may want to know how a change in price due to inflation will affect the complex market dynamics. Through inputting a new price point in the experiments, we can then assess the effect this change in price has on the demand for the product and the demand for competing products. For example, if Gucci raised prices on all its handbags by 10% how does this affect intermediate and bargain designer bags. If sales of the lower-level bags and profit relative to the increase in costs, go up when Gucci raises prices, then Wall Street will be able to know that there will not be inflation in the fashion sector because other companies are making more money relative to their increased costs now that Gucci has raised prices.

On the other hand if when Gucci raises prices the demand of the other products remains the same and the costs go up Wall Street will know that the other lesser tier designers will need to raise prices. This means Wall Street will know inflation can happen before the prices actually change. There are potentially billions of dollars in this information.

### Inflation Trading: Part 2: Effect of Inflation on a Company

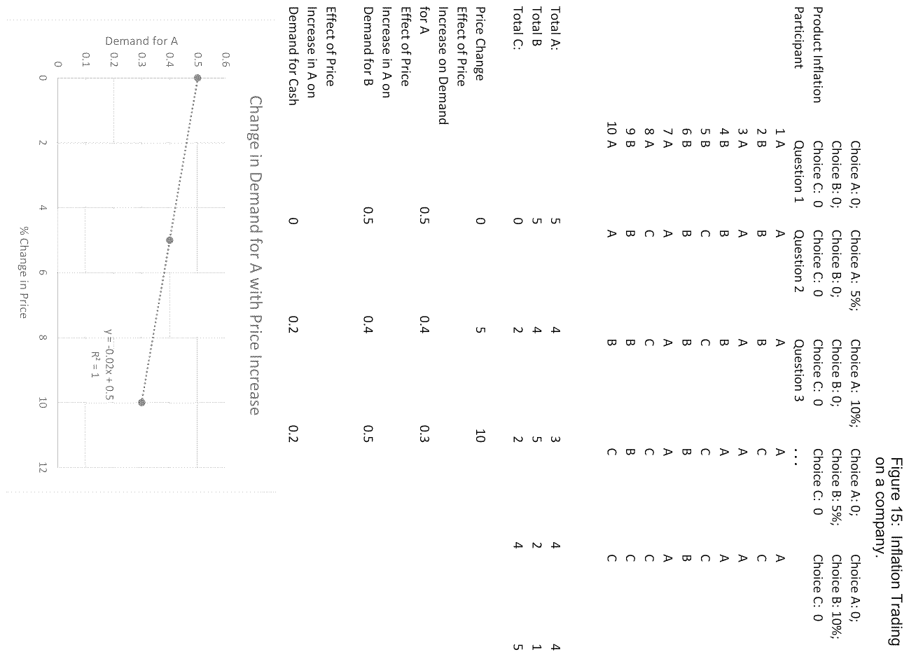

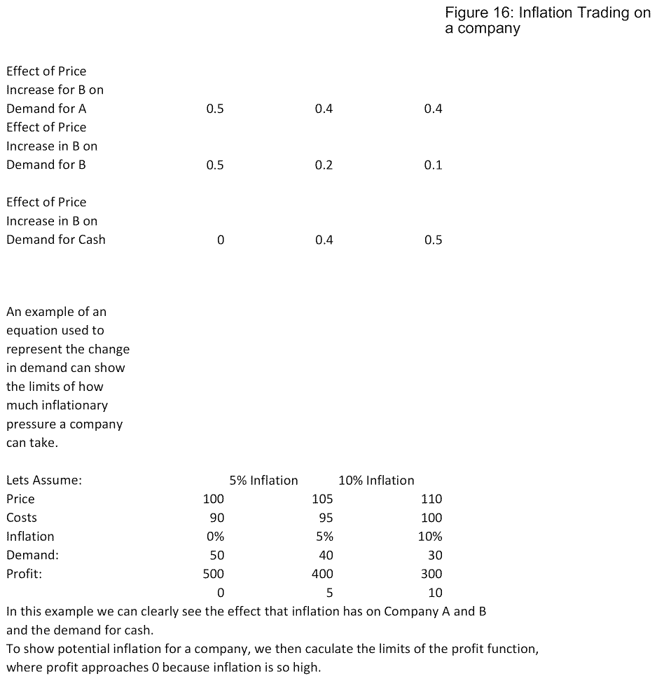

As shown in FIGS. 15, 16, and 17 inflation happens when costs go up due to devaluation of currency or other external factors, which have the effect of raising prices. Wall Street may want to know which companies can survive the inflationary pressures better than others. What we can do is run experiments changing the price of each item the company sells relative to its competitors'prices. In this way we can determine the max price the company can charge before sales plumet. Further, we can estimate the demand function so we know how much money the company will lose with the rising prices. In this way Wall Street can more accurately assess the future market performance for the company based on real data before the company's quarterly report is published. It is like a cheat code for Wall Street.

### Inflation Trading: Part 3: Potential Inflation

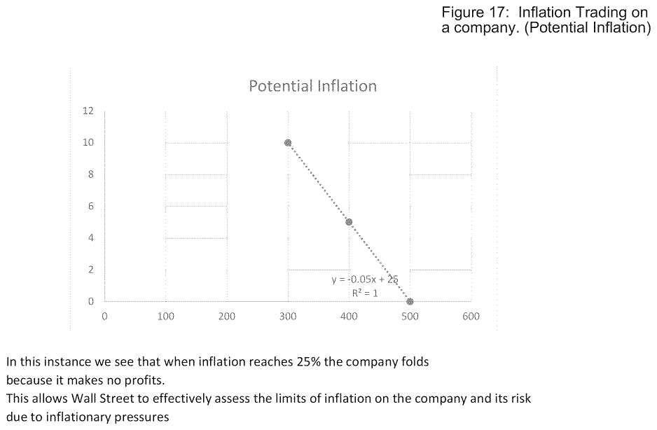

As shown in FIG. 17, For the first time in recorded history in addition to measuring actual inflation we can measure potential inflation. To measure potential inflation, we gradually change the price of each item upward to calculate the demand with a cumulative increase in prices of elite, intermediate, and bargain classes of items. In this way we can measure the potential for cumulative market inflation based on type of item, and whether the item is elite, intermediate or bargain. Doing this across all items will allow us to empirically measure the inflation potential across the fashion industry. We can sell this data to the US government and other individuals who work to address inflationary pressure.

### Experiments for Fashion Companies:

### Mathematical Pricing:

Have you ever wondered if you could charge more for the item you sell and still sell them? Fashion companies do and now it is possible to detect the mathematically perfect price for their products. To do this we run an experiment with their competitor's price as it currently is advertised then we change the price of the item, and we can then estimate the demand at the given price. Then we can maximize sales by finding an ideal price. Further, if the price of a competitor changes, we can tell them the mathematically optimal change the company should make to the price of its item. Clients will pay us to run these surveys to make sure their prices are accurate.

### Discounting:

If a company wants to unload fashion items, we can tell them a price not to go below. For example, if you initially charge 10,000 dollars for a bag and sell five and then drop the price to 100 dollars, the market implodes, and no one wants the bag. The optimal price may be 8,000 or 4,500 at minimum. Knowing this drop off zone is important for discounting. To determine it we run an experiment lowering the price of the item relative to competitors to find the optimal discounting price point and the max discounting price point before demand falls off.

### Auction Services:

If the invention acquires market demand, it will be possible to hold auctions for one of a kind, unique items to this audience. To announce this service, we will hold an auction for one of the most coveted bags in the world—the Berkin Bag. We will correctly price the Berkin bag and then offer our auction service to companies with unique and one of a kind desirable items. Starting out we will charge significantly less than Sotheby but gradually rise prices to be competitive with larger auction houses.

### Demographic Based Demand:

We will know the demand of different items by the race, ethnicity, socio-economic status, and credit worthiness as well as other statistics. Companies can use this to engage in targeted marketing for specific demographics of buyers.

### Experiments Needed:

Ideally, we need to run experiments for a minimum of 1,000 items to be able to fairly articulate the market conditions for consumer demand and inflation within a reasonable degree of error. At the press conference announcing Stella we will hold a spectrum auction for first data rights to this data, second data rights, third data rights, fourth data rights, fifth data rights, and then following this with the right to publish the data in a financial data service. The shareholder activism and earnings trading will be done on a contract basis. The data provided to companies will be done on a contract basis.

### Advertising

Give away 1 bag, sell 100. The goal is to use cost per sale advertising. We reach an agreement with a fashion seller looking to sell items. They agree to cover our costs plus give away one item. We then hold an auction with a link to buy the item. We get twenty percent of the sales.

### What Do we Charge?

1) For providing financial data for inflation and consumer demand:
a. We require our costs paid plus we hold a spectrum auction where parties bid on the following:
   i. Minimum Commitment of Assets to be Traded
   ii. Percent of trading profits from the rights to data
b. The auction is repeated for second data rights, third data rights, fourth data rights and so on.
   i. The subsequent purchasers of data right are informed of the trading volume of the previous data rights, so they can make an informed decision.
   ii. First data rights are for a specific time of advanced notice before the data is handed to the second data rights winner. This time is negotiated with the winning bidder once the realities of the trading operations are set up.
c. There will be a trial period where we will determine the effectiveness of the trading algorithms of different players and then we will adjust the auction according to our own projections of revenue based on the skill of the trader.

2) For providing data for publication in financial data gathering companies such as Bloomberg, we hold an auction for the exclusive license to publish this data per year. This will allow us a baseline revenue.

3) For special projects, we will charge our costs, plus 3.5% of the trading profit.

4) For Non-Auction Experiments for Fashion Companies:
a. We charge our costs, plus 20% of the increase in profit from the previous price point.

5) For Auctions:
a. We charge a flat 20% the sale price fee, plus we keep the advertising revenue.

6) For Ads:
a. Cost paid plus pay per sale advertising. We get twenty percent of the sales.

### Pilot Stella Experiment:

A pilot experiment will be run under the direction of an economist and professor of industrial organization. There will be thirty women who will participate in the chance to win one of two handbags or cash. The questions are below. The questions need to be approved by the economist and are for illustration purpose.

These questions will be the format of the games that people play through Stella-The App.

### Definitions:

Handbag Manufacturer: A handbag that is mass produced for sale exceeding 10,000 bags produced per year.
Elite Handbag Manufacturer: A fashion company with a price point for a handbag in the top 10% average of handbags in a given category.
Intermediate Handbag Manufacturer: A fashion company with a handbag priced in the 50% average of handbags in a given category.
Low Handbag Manufacturer: A fashion company with a handbag priced in the bottom 25% average of handbags in a given category.
Category of Handbag: The Nordstrom Handbag Guide is used as the standard³. ³ https://www.nordstrom.com/browse/content/blog/types-of-purses
There are numerous types of handbags; however, 9 main types: shoulder bag, crossbody bag, satchel, tote bag, evening clutch, backpack purse, woven basket bag, wristlet, hobo bag.
Price Preference Relationship: The relationship between the number of items sold between two choices and each item's price.

### Theory:

This theory is to substantiate a secondary objective to prove that my fashion AI system will collectively lower prices on fashion items which account for 2% of the GDP, helping with inflation.

Relative Price Relations Theory: the price preference relationship will remain consistent when the price of an elite item changes relative to the price of the intermediate item and the intermediate item to the lower item.
Plain English: When the price of an elite bag drops sales will go up and sales of intermediate bags will go down because more people will choose the elite bag over intermediate bags. When the price of an elite bag goes up sales of the elite bag go down and sales of intermediate bags will go up because more people choose the intermediate bag over the elite bag.
   Relative Price Relations and Marginal Returns: There Are Diminishing Marginal returns for price increases and increasing marginal returns for price decreases.
Plain English:
   If the price of the elite bag goes up, the amount the intermediate bag can raise prices decreases the more expensive the elite bag gets.
   If the price of the elite bag goes down, the amount the intermediate bag must lower prices increases the cheaper the elite bag gets.
      Stella Function: the economic equation governing the effect the changes in price of elite goods have on intermediate goods, and on lower goods.

### Details of Experiment:

1. Number of Participants: 30
a. Qualifications: Must be a shopper of women's fashion bags.

2. Goal:
a. The objective of the experiment is to determine four things:
   i. if relative price relations holds between manufacturers of women's handbags.
   ii. If there are diminishing marginal returns for price increases.
   iii. If there are increasing marginal returns for price decreases.
   iv. To find the Stella Function which is the economic equation governing movement of prices between different classes of competing items.
b. To provide illustrations of the viability of “Stella-the App.”

3. Introduction:
a. In this economic experiment you are given the chance to win one of two women's handbags. Economists calculate the value of the chance to win a handbag much like a sweepstakes. If the handbag costs 1000 dollars and there are ten tickets, the value of the sweepstakes ticket is 100 dollars per ticket, if there are 1000 tickets, the value is 1 dollar per ticket.
b. In each question you will be given a choice between keeping a dollar or choosing to win a low bag, intermediate bag, or elite bag. The economic value of the sweepstakes will change to simulate a change in price.

4. Experiment Parameters:
a. There are three bags, one for each category of manufacturer defined above. The bags are valued at 3,000 dollars, 1,500 dollars, and 150 dollars.
b. Step 1:
   i. All three handbags must be the same category of handbag.
   ii. Elite bag must be from: Kering, Chanel, Hermes, or LMVH or subsidiary thereof.
   iii. Intermediate bag must not be from one of these companies.
   iv. Low bag must be from a different manufacturer and different from all of the other companies in the experiment.
   v. All bags must be in stock online meaning no supply and demand issues.
   vi. No bags which look like each other. The bags must be distinct. This experiment is not about proving likelihood of confusion, it is about defining the stella equation.
   vii. The bags must be from competitors.
   viii. Price Points:
      1. Elite Bag: 3,000 dollars,
      2. Intermediate Bag: 1,500 dollars,
      3. Low Bag: 150 dollars.

5. The odds are changed to simulate a change in price.

### Questions:

1. You have to choose between the chance to win one of the two handbags or a chance to win cash:
2 a. A 1 in 6,000 chance to win a 3,000 dollar bag.
   i. Value of Sweepstakes Ticket: $0.50
b. A 1 in 3,000 chance to win a 1,500 dollar bag.
   i. Value of Sweepstakes Ticket: $0.50
c. A 1 in 3,000 chance to win 1,500 dollars cash.
   i. What do you choose:
      1. i, ii, or iii.

2. You have to choose between the chance to win one of the two handbags or a chance to win cash:
a. A 1 in 5,000 chance to win a 3,000 dollar bag.
   i. Value of Sweepstakes Ticket: $0.60
b. A 1 in 3,000 chance to win a 1,500 dollar bag.
   i. Value of Sweepstakes Ticket: $0.50
c. A 1 in 3,000 chance to win 1,500 dollars cash.
   i. What do you choose:
      1. i, ii, or iii.

3. You have to choose between the chance to win one of the two handbags or a chance to win cash:
a. A 1 in 4,000 chance to win a 3,000 dollar bag.
   i. Value of Sweepstakes Ticket: $0.75
b. A 1 in 3,000 chance to win a 1,500 dollar bag.
   i. Value of Sweepstakes Ticket: $0.50
c. A 1 in 3,000 chance to win 1,500 dollars cash.
   i. What do you choose:
      1. i, ii, or iii.

4. You have to choose between the chance to win one of the two handbags or a chance to win cash:
a. A 1 in 5,000 chance to win a 3,000 dollar bag.
   i. Value of Sweepstakes Ticket: $0.60
b. A 1 in 2,000 chance to win a 1,500 dollar bag.
   i. Value of Sweepstakes Ticket: $0.75
c. A 1 in 3,000 chance to win 1,500 dollars cash.
   i. What do you choose:
      1. i, ii, or iii.

5. You have to choose between the chance to win one of the two handbags or a chance to win cash:
a. A 1 in 4,000 chance to win a 3,000 dollar bag.
   i. Value of Sweepstakes Ticket: $0.75
b. A 1 in 1,000 chance to win a 1,500 dollar.
   i. Value of Sweepstakes Ticket: $1.50
c. A 1 in 3,000 chance to win 1,500 dollars cash.
   i. What do you choose:
      1. i, ii, or iii.

6. You have to choose between the chance to win one of the two handbags or a chance to win cash:
a. A 1 in 7,000 chance to win a 3,000 dollar bag.
   i. Value of Sweepstakes Ticket: $0.42
b. A 1 in 3,000 chance to win a 1,500 dollar bag.
   i. Value of Sweepstakes Ticket: $0.50
c. A 1 in 3,000 chance to win 1,500 dollars cash.
   i. What do you choose:
      1. i, ii, or iii.

7. You have to choose between the chance to win one of the two handbags or a chance to win cash:
a. A 1 in 8,000 chance to win a 3,000 dollar bag.
   i. Value of Sweepstakes Ticket: $0.375
b. A 1 in 3,000 chance to win a 1,500 dollar bag.
   i. Value of Sweepstakes Ticket: $0.50
c. A 1 in 3,000 chance to win 1,500 dollars cash.
   i. What do you choose:
      1. i, ii, or iii.

8. You have to choose between the chance to win one of the two handbags or a chance to win cash:
a. A 1 in 7,000 chance to win a 3,000 dollar bag.
   i. Value of Sweepstakes Ticket: $0.428
b. A 1 in 4,000 chance to win a 1,500 dollar bag.
   i. Value of Sweepstakes Ticket: $0.375
c. A 1 in 4,000 chance to win 1,500 dollars cash.
   i. What do you choose:
      1. i, ii, or iii.

9. You have to choose between the chance to win one of the two handbags or a chance to win cash:
a. A 1 in 8,000 chance to win a 3,000 dollar bag.
   i. Value of Sweepstakes Ticket: $0.375
b. A 1 in 5,000 chance to win a 1,500 dollar bag.
   i. Value of Sweepstakes Ticket: $0.3
c. A 1 in 5,000 chance to win 1,500 dollars cash.
   i. What do you choose:
      1. i, ii, or iii.

10.You have to choose between the chance to win one of the two handbags or a chance to win cash:
a. A 1 in 3,000 chance to win a 1,500 dollar bag.
   i. Value of Sweepstakes Ticket: $0.50
b. A 1 in 1,500 chance to win a 750 dollar bag.
   i. Value of Sweepstakes Ticket: $0.50
c. A 1 in 1,500 chance to win 750 dollars cash.
   i. What do you choose:
      1. i, ii, or iii.

11.You have to choose between the chance to win one of the two handbags or a chance to win cash:
a. A 1 in 2,500 chance to win a 1,500 dollar bag.
   i. Value of Sweepstakes Ticket: $0.6
b. A 1 in 1,500 chance to win a 750 dollar bag.
   i. Value of Sweepstakes Ticket: $0.50
c. A 1 in 1,500 chance to win 750 dollars cash.
   i. What do you choose:
      1. i, ii, or iii.

12.You have to choose between the chance to win one of the two handbags or a chance to win cash:
a. A 1 in 2,000 chance to win a 1,500 dollar bag.
   i. Value of Sweepstakes Ticket: $0.75
b. A 1 in 1,500 chance to win a 750 dollar bag.
   i. Value of Sweepstakes Ticket: $0.50
c. A 1 in 1,500 chance to win 750 dollars cash.
   i. What do you choose:
      1. i, ii, or iii.

13.You have to choose between the chance to win one of the two handbags or a chance to win cash:
a. A 1 in 2,500 chance to win a 1,500 dollar bag.
   i. Value of Sweepstakes Ticket: $0.60
b. A 1 in 1,000 chance to win a 750 dollar bag.
   i. Value of Sweepstakes Ticket: $0.75
c. A 1 in 1,500 chance to win 750 dollars cash.
   i. What do you choose:
      1. i, ii, or iii.

14.You have to choose between the chance to win one of the two handbags or a chance to win cash:
a. A 1 in 2,000 chance to win a 1,500 dollar bag.
   i. Value of Sweepstakes Ticket: $0.75
b. A 1 in 500 chance to win a 750 dollar bag.
   i. Value of Sweepstakes Ticket: $1.50
c. A 1 in 1,500 chance to win 750 dollars cash.
   i. What do you choose:
      1. i, ii, or iii.

15.You have to choose between the chance to win one of the two handbags or a chance to win cash:
a. A 1 in 3,500 chance to win a 1,500 dollar bag.
   i. Value of Sweepstakes Ticket: $0.42
b. A 1 in 1,500 chance to win a 750 dollar bag.
   i. Value of Sweepstakes Ticket: $0.50
c. A 1 in 1,500 chance to win 750 dollars cash.
   i. What do you choose:
1. i, ii, or iii.

16.You have to choose between the chance to win one of the two handbags or a chance to win cash:
a. A 1 in 4,000 chance to win a 1,500 dollar bag.
   i. Value of Sweepstakes Ticket: $0.375
b. A 1 in 1,500 chance to win a 750 dollar bag.
   i. Value of Sweepstakes Ticket: $0.50
c. Fifty cents cash.
   i. What do you choose:
      1. i, ii, or iii.

17.You have to choose between the chance to win one of the two handbags or a chance to win cash:
a. A 1 in 3,500 chance to win a 1,500 dollar bag.
   i. Value of Sweepstakes Ticket: $0.428
b. A 1 in 2,000 chance to win a 750 dollar bag.
   i. Value of Sweepstakes Ticket: $0.375
c. A 1 in 1,500 chance to win 750 dollars cash.
   i. What do you choose:
      1. i, ii, or iii.

18.You have to choose between the chance to win one of the two handbags or a chance to win cash:
a. A 1 in 4,000 chance to win a 1,500 dollar bag.
   i. Value of Sweepstakes Ticket: $0.375
b. A 1 in 2,500 chance to win a 750 dollar bag
   i. Value of Sweepstakes Ticket: $0.3
c. A 1 in 2,500 chance to win 750 dollars cash.
   i. What do you choose:
      1. i, ii, or iii.

It is expected that during the life of a patent maturing from this application many relevant AI technologies will be developed and the scope of the term AI is intended to include all such new technologies a priori.

The terms “comprises”, “comprising”, “includes”, “including”, “having” and their conjugates mean “including but not limited to”.

The term “consisting of”means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The term “plurality”means “two or more”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. An economic method applied through a computer, comprising:
outputting the opportunity for a first user to enter a sweepstakes for a first item or second item at a first odds;
receiving input of a choice by a first user for the sweepstakes a first or second item;
outputting a first sweepstakes ticket for the first user;
changing the first odds;
outputting the opportunity for a first user to enter a sweepstakes for a first item or second item at a second odds;
receiving input of a choice by a first user for the sweepstakes a first or second item;
outputting a second sweepstakes ticket for the first user;
outputting a visual image of the drawing to determine the winner of the sweepstakes; and,
holding a drawing for at least one sweepstakes ticket to determine the winner of the sweepstakes.

2. A method of claim 1 where the first and second items are of the same class.

3. A method of claim 1 where the first and second items are of different classes.

4. A method of claim 1 where the preference for the sweepstakes for a first item or second item and the odds are combined to yield an estimated price for the item.

5. A method of claim 1 where the preference for the sweepstakes for a first item or second item and the odds are combined to yield an estimated demand for the item.

6. A method of claim 1, 2, or 4, repeated multiple times with multiple different goods in the same class to determine a price index.

7. A method of claim 1, 2, or 5 repeated multiple times with multiple different goods in the same class to determine a demand index.

8. A method of claim 1, 3, or 4, repeated multiple times with multiple different goods in the same class to determine a price index.

9. A method of claim 1, 3, or 5, repeated multiple times with multiple different goods in the same class to determine a demand index.
